(19) United States
(12) Patent Application Publication
(10) Pub. No.: US 2024/0289136 A1
(43) Pub. Date: Aug. 29, 2024

(54) SYSTEM CONFIGURATION DERIVATION DEVICE AND SYSTEM CONFIGURATION DERIVATION METHOD

(71) Applicant: NEC Corporation, Tokyo (JP)

(72) Inventor: Takuya KUWAHARA, Tokyo (JP)

(73) Assignee: NEC Corporation, Tokyo (JP)

(21) Appl. No.: 18/442,201

(22) Filed: Feb. 15, 2024

(30) Foreign Application Priority Data
Feb. 27, 2023 (JP) 2023-028153

(51) Int. Cl. G06F 9/4401

(52) U.S. Cl. CPC G06F 9/4405

(57) ABSTRACT

The system configuration derivation device includes an optimization problem conversion unit that converts a system optimization problem into a mathematical optimization problem, a problem size reduction unit that reduces the number of variables in the mathematical optimization problem by adding a constraint to the mathematical optimization problem, an optimization unit that computes a solution to the mathematical optimization problem with a reduced number of variables, a gradual optimization unit that sequentially outputs the solution, and progress information of a process, and a solution conversion unit that converts the solution into system configuration information, which is a solution to the system optimization problem and outputs the system configuration information and the progress information.

### CROSS-REFERENCE TO RELATED APPLICATION

This application is based upon and claims the benefit of priority from the prior Japanese Patent Application 2023-028153, filed on Feb. 27, 2023, the entire contents of which are incorporated herein by reference.

### BACKGROUND OF THE INVENTION

### Field of the Invention

This invention relates to a system configuration derivation device and a system configuration derivation method that execute a system configuration optimization procedure to automatically generate a system with a better indicator corresponding to an evaluation value of a system.

### Description of the Related Art

A system configuration derivation device that executes a system configuration optimization procedure is a useful device. The system configuration optimization procedure, for example, inputs an ICT (Information and Communication Technology) system requirement desired by a user (hereinafter referred to as “service requirement”) and an indicator corresponding to an evaluation value of a system (hereinafter referred to as “system evaluation indicator”), and automatically generate a system with a better system evaluation indicator among systems that satisfy the service requirement. It is meaningful to continuously present the best system obtained by the system configuration optimization procedure in terms of the system evaluation indicator at each point in time to a user, along with the value of the system evaluation indicator and the progress of the system configuration optimization procedure.

When constructing an ICT system for the purpose of service operation, etc., it is necessary to design a system configuration. The system configuration design work is required to construct system components and their connection relationships (hereinafter collectively referred to as “system configuration”) necessary to satisfy a requirement of a desired system (hereinafter referred to as “service requirement”). In addition, it is necessary to correctly set all configuration items required for an entire system to operate properly. These tasks require many man-hours.

The problem of obtaining not only a system configuration that satisfies a service requirement, but also the best system configuration in terms of some evaluation indicator that a user has for a system configuration (for example, size of operation costs, high system availability, and acceptable service load) can be regarded as a combinatorial optimization problem defined on variables that determine the system configuration. In particular, when the above problem is regarded as a problem of minimizing an objective function (corresponding to a system evaluation indicator) within the range where the essential condition (corresponding to the service requirement) for the system configuration to be able to operate correctly is satisfied, the above problem can be defined as a constrained mathematical optimization problem.

For example, non patent literature 1 describes a method for automatic system optimization. Specifically, after a functional requirement of a system is conserved in a graph rewriting framework, an objective function is minimized on a constraint obtained.
[Patent Literature 1] Japanese Patent Application Publication No. 2012-159928
[Patent Literature 2] Japanese Patent Application Publication No. 2003-283198
[Patent Literature 3] Japanese Examined Patent Application Publication No. 62-018922
[Non Patent Literature 1] Takayuki Kuroda, Takuya Kuwahara, Kouki Yonaga, Takao Osaki, Masamichi J. Miyama and Masayuki Ohzeki, “Quantum annealing for ICT system design automation”, 2021 IEEE/ACM 21st International Symposium on Cluster, Cloud and Internet Computing (CCGrid), 2021, pp. 156-165
[Non Patent Literature 2] Takayuki Kuroda, Takuya Kuwahara, Takashi Maruyama, Kozo Satoda, Hideyuki Shimonishi, Takao Osaki and Katsushi Matsuda, “Weaver: A Novel Configuration Designer for IT/NW Services in Heterogeneous Environments”, 2019 IEEE Global Communications Conference (GLOBECOM), 2019, pp. 1-6.

### SUMMARY OF THE INVENTION

A System optimization problem can be solved as a mathematical optimization problem, but depending on the scale of a system configuration, it may take an unrealistic amount of time to obtain an optimal solution. In addition, there is a problem that requires a long time even to obtain a feasible solution.

Non patent literature 1 describes an efficient method for solving optimization problems. However, it is reported that even a 60-70 variable problem requires tens of seconds of time. Considering the difficulty of mathematical optimization problems, it is quite possible that solving a problem with hundreds to thousands of variables can take several hours to several days.

Therefore, it can be seen that there are the following two problems in realizing a solution for designing an actual system by a method of optimizing the system configuration as a mathematical optimization problem.

The first problem is that an optimal configuration cannot be presented to a user simply because a problem cannot be solved within a realistic amount of time. This problem is thought to occur when optimizing a very large system that takes several days to complete.

The second problem is that even if it were possible to solve a problem within a realistic amount of time, a user would have to wait for a long time until an optimal configuration is output. Compared to the time it takes to manually consider an optimal configuration, even if an automatic system optimization device takes several days to perform optimization, it may not be an unrealistic time. However, after executing an optimization procedure, a user must continue to wait until an optimization is finished.

In many existing methods, when solving a mathematical optimization problem, it is not possible to observe “progress on the way” as meaningful data for a user. For example, the method using a quantum annealing machine shown in non patent literature 1 repeats quantum annealing until a feasible solution is found by sampling. However, for a problem that is large in scale, it may take several tens of minutes to find a feasible solution. In the meantime, a user continues to wait for an optimization procedure to end, with no indication of when it will end.

The difficulty of optimization problems is intrinsic. It inevitably takes a long time to find a true optimal solution for a problem of a certain size. To solve the above two problems, it is necessary to have a mechanism that can present a system configuration that is a feasible solution as progress on the way, even when a true optimal configuration has not been reached.

Patent literature 1 describes an information processing device for deriving an optimal placement configuration for assigning a virtual machine to one or more physical machines. Patent literature 2 describes a device for displaying a progress status to a user when optimizing a process. Patent literature 3 describes a device that processes the problem of load allocation in a system in a short period of time to find an optimal solution.

It is an object of the present invention to provide a system configuration derivation device and a system configuration derivation method that can compute a better configuration in terms of a system evaluation indicator given by a user for a system that satisfies a service requirement given by a user while presenting the user with a progress status and the best configuration at that point.

A preferred aspect of the system configuration derivation device includes an optimization problem conversion means that converts a system optimization problem into a mathematical optimization problem, a problem size reduction means that reduces the number of variables in the mathematical optimization problem by adding a constraint to the mathematical optimization problem, an optimization means that computes a solution to the mathematical optimization problem with a reduced number of variables, a gradual optimization means that sequentially outputs the solution, and progress information of a process, and a solution conversion means that converts the solution into system configuration information, which is a solution to the system optimization problem, and outputs the system configuration information and the progress information.

A preferred aspect of the system configuration derivation method includes converting, by a computer, a system optimization problem into a mathematical optimization problem, reducing, by the computer, the number of variables in the mathematical optimization problem by adding a constraint to the mathematical optimization problem, computing, by the computer, a solution to the mathematical optimization problem with a reduced number of variables, sequentially outputting, by the computer, the solution, and progress information of a process, and converting, by the computer, the solution into system configuration information, which is a solution to the system optimization problem, and outputting the system configuration information and the progress information.

A preferred aspect of a system configuration derivation program for causing a computer to execute processing includes converting a system optimization problem into a mathematical optimization problem, reducing the number of variables in the mathematical optimization problem by adding a constraint to the mathematical optimization problem, computing a solution to the mathematical optimization problem with a reduced number of variables, sequentially outputting the solution, and progress information of a process, and converting the solution into system configuration information, which is a solution to the system optimization problem, and outputting the system configuration information and the progress information.

According to the present invention, a better configuration of a system that satisfies a service requirement given by a user, in terms of a system evaluation indicator given by a user, can be computed while presenting the user with a progress status and the best configuration at that point.

### BRIEF DESCRIPTION OF THE DRAWINGS

FIG. 1 It depicts a block diagram showing an example configuration of the first example embodiment of a system configuration derivation device.

FIG. 2 It depicts a flowchart showing an operation of an optimization problem conversion unit in a system configuration derivation device of the first example embodiment.

FIG. 3 It depicts a flowchart showing an operation of a gradual optimization unit in a system configuration derivation device of the first example embodiment.

FIG. 4 It depicts a flowchart showing an operation of a problem size reduction unit in a system configuration derivation device of the first example embodiment.

FIG. 5 It depicts an explanatory diagram for explaining a specific image of problem conversion by a problem size reduction unit in a system configuration derivation device of the first example embodiment.

FIG. 6 It depicts a flowchart showing an operation of a solution conversion unit in a system configuration derivation device of the first example embodiment.

FIG. 7 It depicts a block diagram showing an example configuration of the second example embodiment of a system configuration derivation device.

FIG. 8 It depicts a block diagram showing an example configuration of the third example embodiment of a system configuration derivation device.

FIG. 9 It depicts a flowchart showing an operation of a gradual optimization unit in a system configuration derivation device of the third example embodiment.

FIG. 10 It depicts a block diagram showing a computer with a CPU.

FIG. 11 It depicts a block diagram showing the main part of a system configuration derivation device.

FIG. 12 It depicts an explanatory diagram showing an example of a system optimization problem.

FIG. 13 It depicts an explanatory diagram showing an example of a system optimization problem in which a relationship between components changes depending on a solution.

FIG. 14 It depicts an explanatory diagram showing that a solution to a treated system optimization problem corresponds to a specific system configuration.

### DESCRIPTION OF THE PREFERRED EMBODIMENTS

First, a system optimization problem is explained.

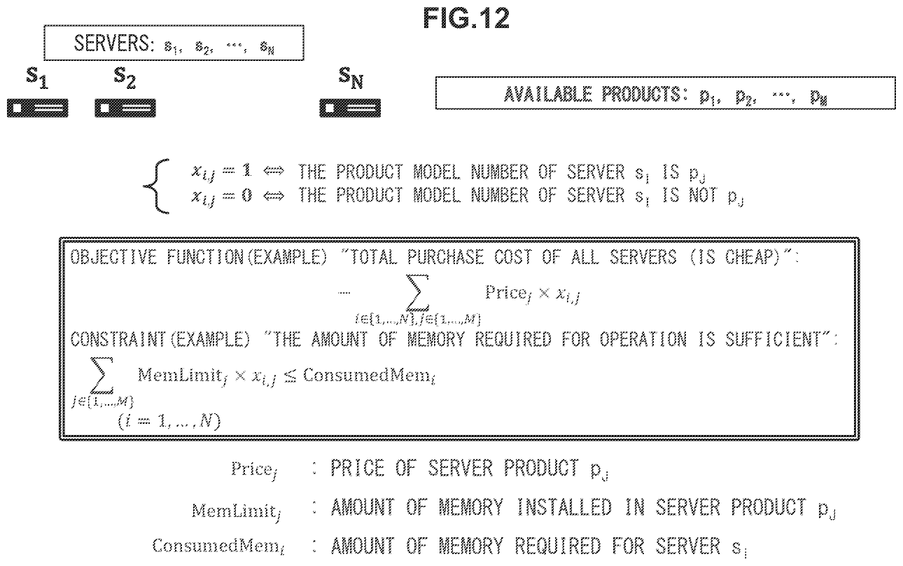

Non patent literature 1 deals with the product selection of servers to be included in a system configuration as an example problem. FIG. 12 is an explanatory diagram showing an example of such a problem (CHOICE-PROBLEM).

In problem CHOICE-PROBLEM, a system includes N servers s₁, s₂, . . . , s_{N} that host application instances, and M types of products p₁, p₂, . . . , p_{M} are available for each server. By assigning the truth or falsehood of the fact that “product pⱼ is adopted in server sᵢ” to a binary variable (a variable that takes 0 or 1 as a value) x_{i,j}, values such as “purchase cost of server sᵢ” “operating cost of server sᵢ” and “available memory amount of server sᵢ” can be defined as expressions of variables {x_{i,j}|1≤i≤N, 1≤j≤M}. Constraints such as “the total operating cost of all servers in the system is less than or equal to *** yen”, “the amount of available memory on server sᵢ is more than an amount required to properly operate the services hosted on server sᵢ”, can also be expressed. With these constraints and values, the server product selection can be treated as a mathematical optimization problem on the binary variables {x_{i,j}|1≤i≤N,1≤j≤M}.

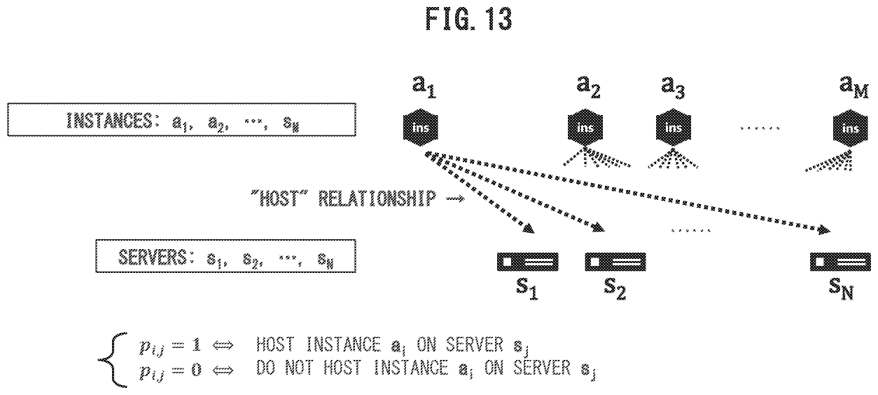

In the examples described in non patent literature 1, the result of the mathematical optimization does not affect the relationship among components of a system. However, there are possible examples where these may change depending on the result of the mathematical optimization problem. FIG. 13 is an explanatory diagram showing the problem HOST-PROBLEM as an example of such a problem. It should be noted that FIG. 13 shows an example of a system optimization problem in which the relationship among components changes depending on the solution.

In the problem HOST-PROBLEM showed in FIG. 13, N servers s₁, s₂, . . . , s_{N} and M application instances a₁, a₂, . . . , a_{M} that be included in a system is being treated. The problem HOST-PROBLEM differs from the problem CHOICE-PROBLEM above in that the product of each server has already been determined, but the “HOST” relationship between server and instance is not explicit.

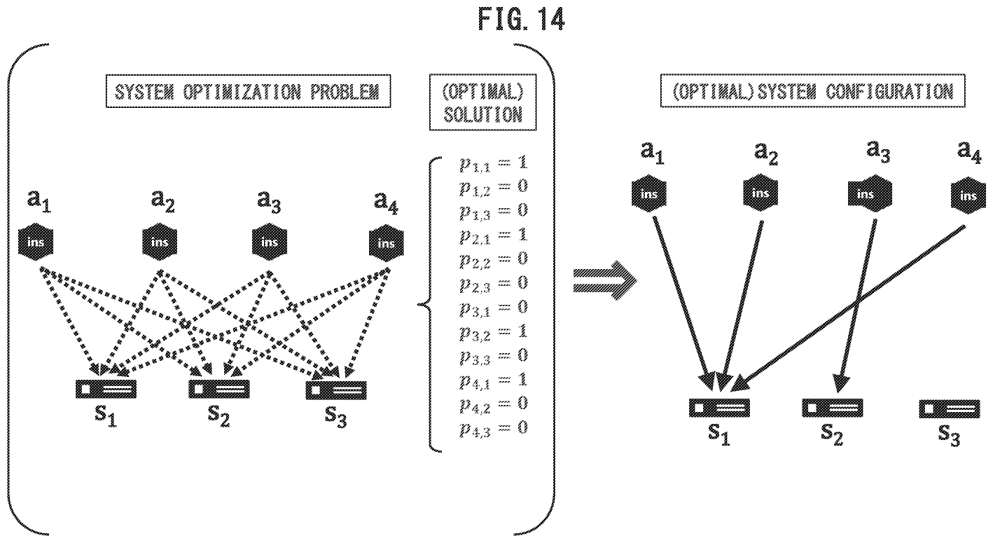

The problem HOST-PROBLEM can be encoded into a mathematical optimization problem like CHOICE-PROBLEM by assigning the truth or falsehood of “instance aᵢ is hosted on server sⱼ” to a binary variable p_{i,j}. The solution to the mathematical optimization problem thus obtained can be interpreted as representing the “HOST” relationship between instances and servers. FIG. 14 is an explanatory diagram showing that a solution to a system optimization problem corresponds to a concrete system configuration. FIG. 14 shows an example of a solution shown in FIG. 13 and a system configuration obtained by interpreting it as a “HOST” relationship.

Next, how a system optimization problem that is input information to a system configuration derivation device is defined will be explained.

First, the definition of “system configuration” is explained.

The system configuration treated in this specification is defined in the manner of graphically representing abstract or concrete system configurations used in non patent literature 2, etc. More specifically, it is defined by components, which represent logical or physical “parts” in the system, and relations, which represent relationships among components. As components and relations, there are “concrete” and “abstract” components. In addition, types, identifiers, and associated parameters are defined.

In addition, a constraint on parameters (hereinafter referred to as “parameter constraint”) can be attached to the above system configuration. The parameter constraint expresses conditions necessary for a system to operate properly (such as “performance” requirements) and conditions desired by a user for a system (such as requirements regarding “budget” and “performance”).

A system configuration in which all components and relations are concrete and parameters are fixed with normal values (in the sense that all constraints are satisfied) can be implemented as a properly working ICT system.

Next, a “system optimization problem” treated in this specification will be explained.

A system optimization problem treated in this specification is defined by two elements. They are “indefinite system configuration” and “system evaluation indicator”.

As described above, the “system evaluation indicator” corresponds to a function that receives a system configuration and returns an evaluation value. A larger evaluation value shall be interpreted as a “good” system configuration in terms of the system evaluation indicator.

“Indefinite system configuration” means a system configuration that has one or more of the following types of indefinite elements.

[Indefinite component set] A set of components that includes one parameter whose setting value has not been determined (undetermined parameter). However, it is assumed that in one indefinite component set, an undetermined parameter of each component is common (for example, “MACHINE” type components M1, M2, and M3 whose parameter “product type number” is undetermined).

[Indefinite relation set] A set of relations whose connection destination is not determined. However, it is assumed that in one indefinite relation set, candidate components that each relation can connect to are common (for example, three “HOST” type relations with “MACHINE” type components M1, M2, M3, M4 as candidate connection destinations and “APP” type components A1, A2, A3 as connection sources).

A system configuration can be obtained by defining all the indefinite elements included in an indefinite system configuration. The obtained system configuration is called a “solution” to a system optimization problem.

A solution to a system optimization problem that satisfies all accompanying parameter constraints is called a “feasible solution” to a system optimization problem. The feasible solution corresponds to a system configuration that operates normally as an ICT system.

Further, the best feasible solution to a system optimization problem in terms of a system evaluation indicator is called an “optimal solution”.

Obtaining a feasible solution to a system optimization problem, especially a feasible solution with a higher system evaluation indicator, is called solving that system optimization problem.

Next, a definition of a constrained mathematical optimization problem treated in this specification will be explained.

A constrained mathematical optimization problem treated in this specification (hereinafter simply referred to as “mathematical optimization problem”) is basically identical to those defined in general. In other words, a mathematical optimization problem is defined by the following three elements.

[Decision variable] A variable representing a value to be determined by solving a mathematical optimization problem X=(x₁, x₂, . . . , xₙ).

[Objective function] A function f(X) that returns a value expressing the “goodness” of a solution.

[Constraint list] A list of equality g(X)=c or inequality g(X)≤c representing a condition that a decision variable must satisfy.

The general definition has been explained above, but in addition, in this specification, a mathematical optimization problem is assumed to have the following elements.

[One-hot vector list] A vector sequence of decision variables (p₁, p₂, . . . , pₖ) that satisfy the following three properties (OVL-1)-(OVL-3).
(OVL-1) Included all decision variables take the value of 0 or 1.
(OVL-2) The all vectors p₁, . . . , pₖ have the same length.
(OVL-3) For all vectors pᵢ, the constraint list contains a constraint (one-hot constraint) equivalent to “for elements of pᵢ, exactly one variable only takes the value of 1 and the other variables take the value of 0”.

In other words, a one-hot vector sequence corresponds to a vector sequence in which some of the decision variables included in a mathematical optimization problem are grouped together based on information about which undefined part of a system they originate from.

The number of elements in a one-hot vector sequence is referred to as the “size” of the one-hot vector sequence in this specification. Further, the maximum size of a one-hot vector sequence that a mathematical optimization problem has is called the “size” of the mathematical optimization problem itself.

Hereinafter, example embodiments of the present invention will be explained with reference to the drawings.

### Example Embodiment 1

### [Description of Configuration]

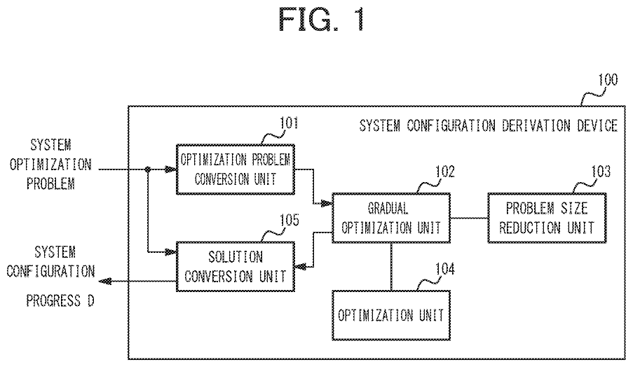

The first example embodiment is described below with reference to the drawings. FIG. 1 is a block diagram showing an example configuration of the first example embodiment of a system configuration derivation device 100. The arrows in FIG. 1 indicate a direction of signal (data) flow in a straightforward manner, but do not exclude bidirectionality. This is true for other block diagrams as well.

A system configuration derivation device 100 of this example embodiment includes an optimization problem conversion unit 101, a gradual optimization unit 102, a problem size reduction unit 103, an optimization unit 104, and a solution conversion unit 105.

The optimization problem conversion unit 101 converts a system optimization problem into a mathematical optimization problem and mapping information that indicates the correspondence between the original problem and the mathematical optimization problem.

The gradual optimization unit 102 inputs a mathematical optimization problem. During execution, the gradual optimization unit 102 outputs a feasible solution to the mathematical optimization problem, and a degree of progress as progress on the way. The gradual optimization unit 102 eventually outputs an optimal solution to the mathematical optimization problem.

The problem size reduction unit 103 receives as input a mathematical optimization problem and size information (integer values). The problem size reduction unit 103 outputs a mathematical optimization problem with fewer variables than the original problem by adding constraints to the constrained mathematical optimization problem.

The optimization unit 104 receives a mathematical optimization problem as input. The optimization unit 104 outputs a true optimal solution of the mathematical optimization problem or a feasible solution that approximates a true optimal solution in terms of the value of an objective function.

The solution conversion unit 105 inputs a solution to a mathematical optimization problem generated based on a system optimization problem. The solution conversion unit 105 outputs a system configuration corresponding to a solution of a mathematical optimization problem by reflecting it in an indefinite system configuration of a system optimization problem.

### [Description of Operation]

The system configuration derivation device 100 receives a system optimization problem as input, executes an optimization process to find an optimal solution to the system optimization problem, and outputs an obtained optimal solution.

Further, during the optimization process, the system configuration derivation device 100 outputs a feasible solution and a degree of progress of the input system optimization problem as progress on the way.

Next, a detailed description of the processing of each block of the system configuration derivation device 100 will be explained.

First, an operation of the optimization problem conversion unit 101 is explained.

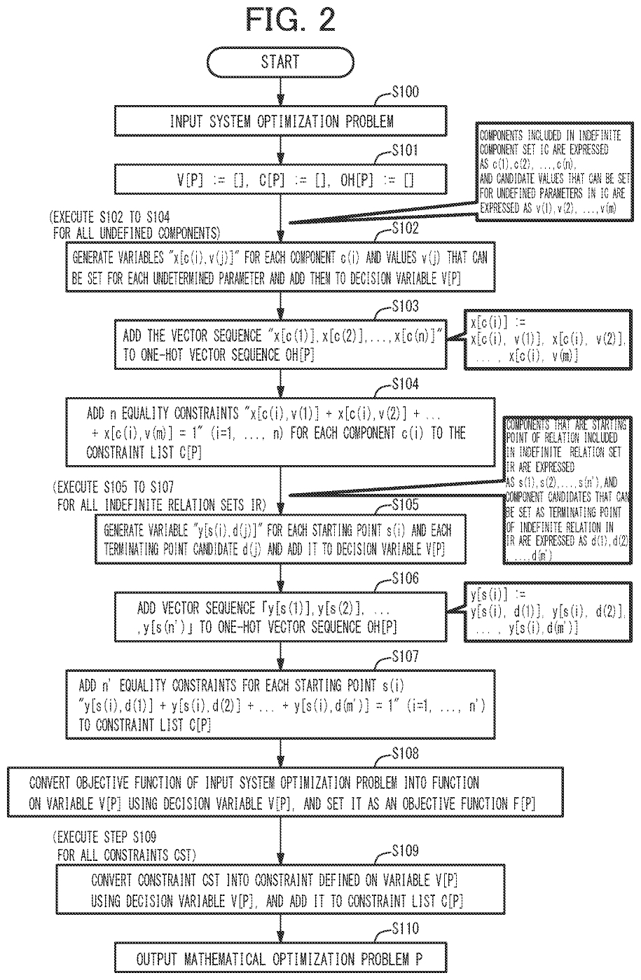

FIG. 2 is a flowchart showing an operation of the optimization problem conversion unit 101.

The optimization problem conversion unit 101 receives a system optimization problem as an input (step S100).

The optimization problem conversion unit 101 initializes a data structure of a mathematical optimization problem P to be returned as an output. Specifically, the optimization problem conversion unit 101 initializes the decision variable V[P], constraint list C[P], and one-hot vector sequence OH[P] of P with an empty list (step S101).

The optimization problem conversion unit 101 executes steps S102 through S104 for all indefinite component sets IC included in an indefinite system configuration of the system optimization problem.

In the following explanation, components included in an indefinite component set IC are expressed as c(1), c(2), . . . , c(n), and candidate values that can be set for undetermined parameters in IC are expressed as v(1), v(2), . . . , v(m).

The optimization problem conversion unit 101 generates variables “x[c(i), v(j)]” for each component c(i) and values v(j) that can be set for each undetermined parameter and adds them to the decision variable V[P] (step S102).

The optimization problem conversion unit 101 adds the vector sequence “x[c(1)], x[c(2)], . . . , x[c(n)]” consisting of variables generated in the process of step S102 to the one-hot vector sequence OH[P] (step S103). The above x[c(i)] represents vectors x[c(i), v(1)], x[c(i), v(2)], . . . , x[c(i), v(m)] of variables regarding component c(i).

The optimization problem conversion unit 101 adds n equality constraints “x[c(i), v(1)]+x[c(i), v(2)]+ . . . +x[c(i), v(m)]=1” (i=1, . . . , n) for each component c(i) to the constraint list C[P] (step S104).

It should be noted that these constraints express that “the value that is actually set for a parameter of a certain component is limited to one of the settable values”, intuitively.

The optimization problem conversion unit 101 executes the processes of steps S105 to S107 for all indefinite relation sets IR included in an indefinite system configuration of the system optimization problem.

In the following description, components that are a starting point of a relation included in an indefinite relation set IR are expressed as s(1), s(2), . . . , s(n′), and component candidates that can be set as a terminating point of an indefinite relation in IR are expressed as d(1), d(2), . . . , d(m′).

The optimization problem conversion unit 101 generates variables “y[s(i), d(j)]” for each starting point s(i) and each terminating point candidate d(j) and adds them to the decision variable V[P] (step S105).

The optimization problem conversion unit 101 adds the vector sequence “y[s(1)], y[s(2)], . . . , y[s(n′)]” consisting of variables generated in the process of step S102 to the one-hot vector sequence OH[P] (step S106). y[s(i)] represents vectors y[s(i), d(1)], y[s(i), d(2)], . . . , y[s(i), d(m′)] of variables regarding component c(i).

The optimization problem conversion unit 101 adds n′ equality constraints for each starting point s(i) “y[s(i), d(1)]+y[s(i), d(2)]+ . . . +y[s(i), d(m′)]=1” (i=1, . . . , n′) to the constraint list C[P] (step S107).

It should be noted that these constraints express that “a terminating point of a certain relation is limited to one of the candidates”, intuitively.

The optimization problem conversion unit 101 converts an objective function of the input system optimization problem into a function on a variable V[P] using the decision variable V[P] added in the process of step S102 and the process of step S105, and set it as an objective function F[P] (step S108).

The optimization problem conversion unit 101 executes the process of step S109 for each constraint CST included in a constraint list of the input system optimization problem.

In other words, the optimization problem conversion unit 101 converts the constraint CST into a constraint defined on the variable V[P] using the decision variable V[P] that was added in the processing of step S102 and step S105, and adds it to the constraint list C[P] (step S109).

The optimization problem conversion unit 101 outputs a mathematical optimization problem P consisting of the decision variable V[P], the objective function F[P], the list of constraints C[P], and the one-hot vector sequence OH[P] (step S110).

The above is a description of the operation of the optimization problem conversion unit 101.

Next, specific examples of conversion by the optimization problem conversion unit 101 will be explained.

Assume that the optimization problem conversion unit 101 inputs a system optimization problem HOST-PROBLEM shown in FIG. 13. However, assume that the number of instances is 8 and the number of servers is 6. An objective function is assumed to be “a sum of a power consumption of a₁, . . . , a₆ (=a total power consumption of a system is small)”. Assume that a constraint for each server sⱼ in a constraint list is “a memory required for an operation of all instances hosted on server sⱼ is less than or equal to MemLimitⱼ”. In addition, “power consumption when instance aᵢ runs on server sⱼ” is expressed as Power_{i,j}. “Amount of memory used by instance aᵢ for operation” is expressed as ConsumedMemᵢ. “Amount of memory installed in server sⱼ” is expressed as MemLimitⱼ.

HOST-PROBLEM does not have an indefinite component set, but has eight “HOST” type relations with each instance a₁, . . . , a₈ as a starting point as an indefinite relation set. Therefore, a total of 48 variables corresponding to these “y[a₁][s₁], y[a₁][s₂], . . . , y[a₁][s₆], y[a₂][s₁], . . . , y[a₈][s₆] are set to a decision variable V. As a one-hot vector sequence, one vector sequence “(y[a₁], y[a₂], . . . , y[a₈])” is set. In addition, a constraint on these variables “y[aᵢ][s₁]+ . . . +y[aᵢ][s₆]=1” is set as a constraint.

The objective function “total power consumption of a₁, . . . , a₆” is set as a function F(V)=Σ_{i,j} Power_{i,j}y[aᵢ][sⱼ] on V by replacing “a power consumption of aᵢ”, which was indefinite due to a presence of indefinite relations, by an expression “Σⱼ Power_{i,j}y[aᵢ][sⱼ]” using decision variables. Note that i is one of 1 to 8, and j is one of 1 to 6.

The constraint “Memory required to run all instances hosted on server sⱼ is less than or equal to MemLimitⱼ” is set as a constraint Σᵢ ConsumedMemᵢy[aᵢ][sⱼ]≤MemLimitⱼ on V by replacing “Memory consumption of all instances running on server sⱼ”, which was indefinite due to a presence of indefinite relations, by an expression “Σᵢ ConsumedMemᵢy [aᵢ][sⱼ]” using decision variables. Note that i is one of 1 to 8, and j is one of 1 to 6.

The above is a description of a specific example of conversion by the optimization problem conversion unit 101.

Next, an operation of the gradual optimization unit 102 will be described.

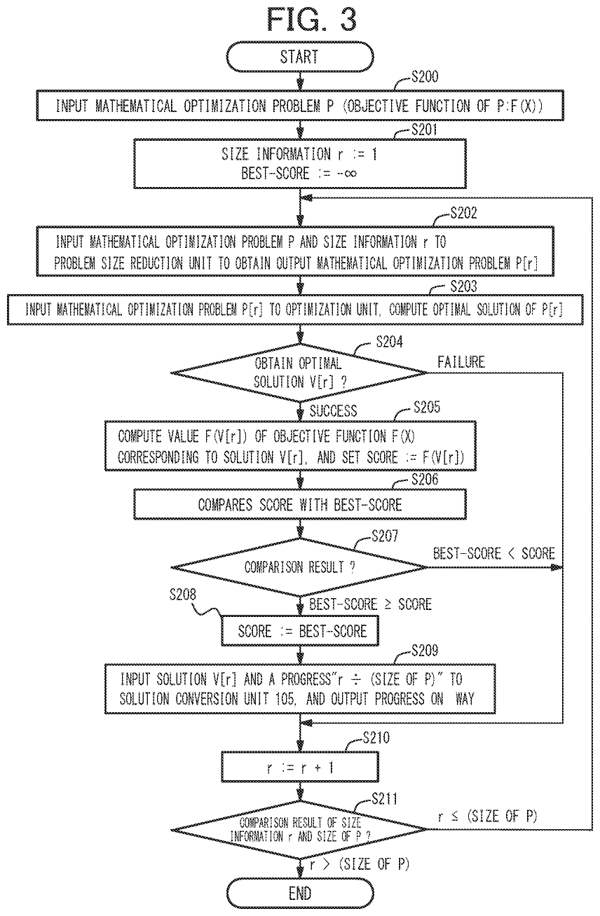

FIG. 3 is a flowchart showing an operation of the gradual optimization unit 102.

The gradual optimization unit 102 inputs a mathematical optimization problem P (step S200). An objective function of a mathematical optimization problem is denoted by F(X).

The gradual optimization unit 102 initializes size information r with 1 and the best-score BEST-SCORE with −∞ (negative infinity) (step S201).

The gradual optimization unit 102 inputs the mathematical optimization problem P and size information r to the problem size reduction unit 103 to obtain an output mathematical optimization problem P[r] (step S202).

The gradual optimization unit 102 inputs the mathematical optimization problem P[r] to the optimization unit 104. The optimization unit 104 computes an optimal solution of P[r] (step S203). When the optimization unit 104 succeeds in obtaining an optimal solution V[r], the process moves to step S205 (step S204). When the optimization unit 104 fails to obtain an optimal solution, the process moves to step S210 (step S204).

The gradual optimization unit 102 computes a value F(V[r]) of the objective function F(X) corresponding to the solution V[r], and sets it as SCORE:=F(V[r]) (step S205).

The gradual optimization unit 102 compares SCORE with BEST-SCORE (step S206); When SCORE is larger, the process moves to step S210 (step S207). Otherwise, the process moves to step S208 (step S207).

In step S208, the gradual optimization unit 102 updates SCORE with the BEST-SCORE value.

The gradual optimization unit 102 inputs the solution V[r] and a degree of progress d (“r÷(size of P)”) to the solution conversion unit 105, and outputs progress on the way (step S209). The degree of progress d corresponds to progress information for an entire optimization procedure (optimization process).

In step S210, the gradual optimization unit 102 increases the size information r by 1.

The gradual optimization unit 102 terminates the operation when the size information r is larger than the size of P (step S209). Otherwise, the process returns to step S202 (step S211).

The above is a description of an operation of the gradual optimization unit 102.

Next, an operation of the problem size reduction unit 103 will be explained. The problem size reduction unit 103 receives a mathematical optimization problem P and size information r as inputs. Then, the problem size reduction unit 103 outputs a mathematical optimization problem P[r] with the property that “a feasible solution of P[r] is also a feasible solution of P”.

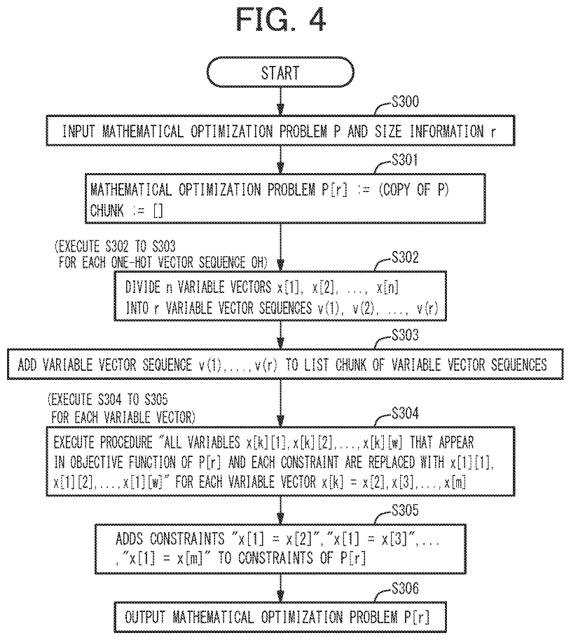

FIG. 4 is a flowchart showing an operation of the problem size reduction unit 103.

The problem size reduction unit 103 receives a mathematical optimization problem P and size information r as inputs (step S300).

The problem size reduction unit 103 initializes a mathematical optimization problem P[r] as a copy of P (P[r]:=P) (step S301). In addition, he problem size reduction unit 103 initializes a list of vector sequences CHUNK with an empty list (step S301).

The problem size reduction unit 103 executes steps S302 to S303 for each one-hot vector sequence OH=(x[1], x[2], . . . , x[n]) in the mathematical optimization problem P whose size is larger than r.

The problem size reduction unit 103 divides n variable vectors x[1], x[2], . . . , x[n] into r variable vector sequences v(1), v(2), . . . , v(r) (step S302). Specifically, the problem size reduction unit 103 divides each variable so that it is included in exactly one variable vector v(i).
(Supplement 1) As an example of a method for dividing a variable vector into r vectors in step S302, a method for dividing a sequence in which n variable vectors are arranged in order into r equal parts (when there is a fraction, only the last variable vector v(r) will be a vector with fewer elements.) may be considered.
(Supplement 2) Another example of a method for dividing a variable vector into r vectors in step S302, a method for dividing a sequence in which n variable vectors are arranged in order into r vector sequences by repeating the following procedure 1 “Divide k variable vector sequence into k+1 variable vector sequence” r−1 times may be considered.
(Procedure 1) Assume that one vector sequence v (size is s) with the largest number of elements is selected from k variable vector sequences, and a power of 2 (=1, 2, 4, 8, 16, . . . ) smaller than s is set to s′. By dividing v into “Vector sequence taken from s′ from the beginning of v” and “Vector sequence taken from s−s′ from the end of v”, k+1 new variable vector sequences can be obtained.
(Supplement 3) Supplements 1 and 2 are examples of methods to divide variables into r vectors. The methods by which the problem size reduction unit 103 in this example embodiment divides variables into r vectors in the process of step S302 are not limited to those. As long as the principle of dividing all variables into exactly one vector is adhered to, it is possible, for example, to use methods such as rearranging variables in a particular way and then dividing them, or random division.

The problem size reduction unit 103 adds the variable vector sequence v(1), . . . , v(r) obtained in the process of step S302 in the previous loop to the list CHUNK of variable vector sequences (step S303).

The problem size reduction unit 103 executes the processes of steps S304 to S305 for each variable vector sequence (x[1], x[2], . . . , x[m]) included in CHUNK.

The problem size reduction unit 103 executes the procedure “All variables x[k][1], x[k][2], . . . , x[k][w] that appear in an objective function of P[r] and each constraint are replace with x[1][1], x[1][2], . . . , x[1][w]” for each variable vector x[k]=x[2], x[3], . . . , x[m] (step S304).

The problem size reduction unit 103 adds constraints “x[1]=x[2]”, “x[1]=x[3]”, . . . , “x[1]=x[m]” to constraints of P [r] (step S305).

The problem size reduction unit 103 outputs a mathematical optimization problem P[r] (step S306).

The above is a description of an operation of the problem size reduction unit 103.

Next, specific examples of problem size reduction by the problem size reduction unit 103 will be explained. Assume that a problem obtained by converting HOST-PROBLEM described as a specific example of input to the optimization problem conversion unit 101 is input to the problem size reduction unit 103. Also, assume that R=4 is input to the problem size reduction unit 103 as size information.

Assume that a one-hot vector sequence (y[a₁], . . . , y[a₈]) is divided into four equal parts from the beginning and into a list consisting of four vector sequences (y[a₁], y[a₂]), (y[a₃], y[a₄]), (y[a₅], y[a₆]), (y[a₇], y[a₈]).

Then, four constraints y[a₁]=y[a₂], y[a₃]=y[a₄], y[a₅]=y[a₆], y[a₇]=y[a₈] are added to the constraint list, and an objective function and other constraints y₂ₖ (k=1, 2, 3, 4) in the constraint list are replaced by y₂ₖ₋₁ respectively. For example, an objective function F(V)=Σ_{i,j}Power_{i,j}y[aᵢ][sⱼ] becomes F(V)=Σ_{k,j} (Power_{2k-1,j}+Power_{2k,j})y[a₂ₖ₋₁][sⱼ] by replacement. Note that i is one of 1 to 8, j is one of 1 to 6, and k is one of 1 to 4.

The above is a specific example of problem size reduction by the problem size reduction unit 103. Hereinafter, how a problem is further simplified by processing the problem size reduction unit 103 will be explained with reference to the drawings.

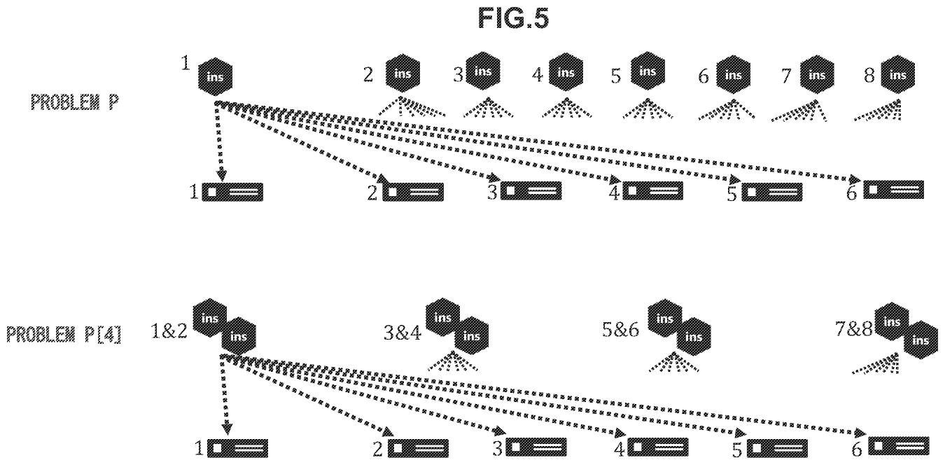

FIG. 5 is an explanatory diagram for explaining an image of converting HOST-PROBLEM P with size information 4. The operation of dividing the variable y[aᵢ][sⱼ] into four parts and adding constraints y[a₁]=y[a₂], y[a₃]=y[a₄], y[a₅]=y[a₆], y[a₇]=y[a₈], as shown in FIG. 5, intuitively corresponds to an operation “make endpoints of an indefinite relation starting from two components a2k−1, a2k the same”.

The conversion means that an original problem of setting destinations of eight relations has been converted to a problem of setting destinations of four relations. In general, the latter is the easier problem. In general, the smaller the size information r, the easier the problem is because it is converted into a problem with substantially fewer variables in the problem.

(Supplement) Here, it should be noted that conversion by the problem size reduction unit 103 may cause a phenomenon that can be said to “deteriorate the quality of a solution to a problem” in two senses. One is that, for example, when a true optimal solution is a configuration in which a₁ is hosted in s₁ and a₂ is hosted in s₂, a solution to P[4] does not include this configuration. Therefore, a true optimal solution cannot be obtained by solving P[4]. Another is that in a case where a₁ and a₂ cannot be hosted on the same server due to the amount of memory consumed, there is no longer even a viable solution for P[4]. It is considered that such a phenomenon is more likely to occur as the size information r used for conversion is smaller. Therefore, the result of the problem size reduction unit 103 is a trade-off between the simplicity of the problem and the “quality of the solution”.

The above is an intuitive explanation of the meaning of problem size reduction by the problem size reduction unit 103.

Next, an operation of the optimization unit 104 in this example embodiment will be explained.

The optimization unit 104 takes a mathematical optimization problem as an input and outputs its true optimal solution or a feasible solution that approximates it in terms of a value of an objective function. In the following description, they are collectively referred to as “good feasible solutions”.

A solution V to a mathematical optimization problem P is data that expresses “the assignment of values to each decision variable in P”. In this example embodiment, values assigned to decision variables are 0 or 1. Therefore, a solution is expressed as “a set of variables such that a value is 1”. That is, for each decision variable x in P, when x is included in V, then x is assigned a value of 1 in V. When x is not included in V, 0 is assigned to x in V as the value.

In this example embodiment, the method by which the optimization unit 104 finds a good executable solution is not limited to a specific method. Some specific methods that can be adopted are illustrated below.

The first method uses linear programming. This method is applicable only when a linear programming problem is given as input. Well-known algorithms such as the simplex method and the internal point method are available. Although these methods are limited in their applicability, they are characterized by their ability to obtain a true optimal solution in a relatively realistic time frame.

The second method uses annealing. This method is based on the natural law that “physical states transition toward lower internal energy”. There are a pseudo-annealing method that simulate a physical environment on a computer, and a method that use special-purpose hardware in which the above physical phenomena actually operate.

For example, in non patent literature 1, a computation is based on the latter method. Specifically, in the method described in non patent literature 1, in order to find a good feasible solution to a mathematical optimization problem, after the mathematical optimization problem is converted into an unconstrained mathematical optimization problem, an annealing method with a quantum annealing machine is executed, which realizes a process of transition from an initial state in which all solution candidates are superimposed quantum mechanically to a ground state (=lower energy level).

The above is a specific realization of the optimization unit 104 in this example embodiment.

However, as mentioned above, the specific method of realizing an operation of the optimization unit 104 in this example embodiment is not limited to the above examples.

Next, an operation of the solution conversion unit 105 will be explained.

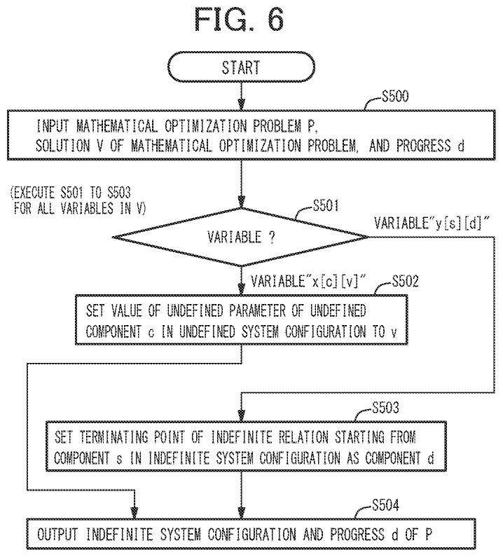

FIG. 6 is a flowchart showing an operation of the solution conversion unit 105.

The solution conversion unit 105 receives as input a system optimization problem P, a solution V of a mathematical optimization problem converted from the optimization problem P, and a degree of progress d (step S500).

It should be noted that “the solution V to the mathematical optimization problem” input here is expressed as “a set of variables whose values are assigned to 1”, as explained in the description of the operation of the optimization unit 104.

The solution conversion unit 105 executes a process from step S501 onward for all variables in V.

When a variable is “x[c][v]” (c is an indefinite component and v is an undetermined parameter), the solution conversion unit 105 executes a process of step S502 (step S501). When a variable is “y[s][d]” (s and d are a starting point and terminating point of an indefinite relation, respectively), the solution conversion unit 105 executes a process of step S503 (step S501).

In step S502, the solution conversion unit 105 sets a value of an undetermined parameter of an indefinite component c in an indefinite system configuration to v.

In step S503, the solution conversion unit 105 determines a terminating point of an indefinite relation starting from component s in an indefinite system configuration to be component d.

After the execution of steps S502 and S503 for all variables in V are completed, all undetermined elements in an indefinite system configuration are eliminated by the constraint (one-hot constraint) added by the optimization problem conversion unit 101 when adding decision variables. In other words, an embodied system configuration is obtained.

The solution conversion unit 105 outputs an indefinite system configuration and a degree of progress d of the embodied optimization problem P (step S504).

The above is a specific realization of an operation of the solution conversion unit 105.

### [Description of Effect]

The optimization problem conversion unit 101 in the system configuration derivation device 100 of this example embodiment converts a system optimization problem into an equivalent mathematical optimization problem. The gradual optimization unit 102 can execute an optimization of a system configuration by outputting a solution to a mathematical optimization problem.

In addition, the problem size reduction unit 103 adds a constraint that treats multiple variables together as if they were one variable. Therefore, a given mathematical optimization problem is converted into a problem that has substantially fewer variables and can be solved faster. An output problem P[r] is simplest when input size information r is “1”. The larger the size information r is, the more difficult the problem P[r] becomes. It should be noted that when the size information r is larger than or equal to the size of an original problem, the difficulty of problem P[r] is exactly the same as the original problem.

Then, in this example embodiment, the gradual optimization unit 102 sequentially solves P[1], P[2], . . . , obtained by the problem size reduction unit 103. Then, the gradual optimization unit 102 outputs obtained solutions sequentially. Although the “quality” of a solution in terms of an objective function is not good, a problem with small size information r can be solved in a very short time compared to an original problem. Therefore, the gradual optimization unit 102 can output information that corresponds to progress on the way during a procedure to find an optimal solution to an input problem.

In addition, the gradual optimization unit 102 can also output a degree of progress obtained from size information.

Accordingly, even for a problem that is too large to directly find a true optimal solution, the system configuration derivation device 100 of this example embodiment can proceed with an optimization procedure while presenting a user with the best solution at the current state, which is still in progress on the way, and a degree of progress, which indicates how close to a true solution has been computed, in a short time.

### Example Embodiment 2

### [Description of Configuration]

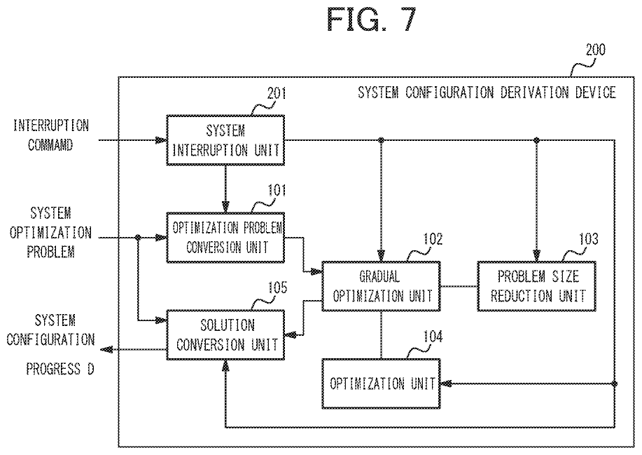

Next, the second example embodiment will be explained with reference to the drawings. FIG. 7 is a block diagram showing an example configuration of a system configuration derivation device 200 of the second example embodiment.

The system configuration derivation device 200 has a system interruption unit 201 in addition to the configuration of the system configuration derivation device 100.

In this example embodiment, the system interruption unit 201 is connected to all other blocks. Further, the system interruption unit 201 always accepts an interrupt command from a user in a standby state during operation.

### [Description of Operation]

A basic operation of the system configuration derivation device 200 in this example embodiment is the same as that of the system configuration derivation device 100 in the first example embodiment.

The system interruption unit 201 can issue an interrupt instruction to other connected devices. When a block receives an interrupt instruction, the block immediately stops operating in case the block is in operation. A block that receives an interrupt instruction does nothing in case the block is not in operation.

The system interruption unit 201 issues interrupt instructions to all other blocks at the time of receiving an interrupt command from a user. Therefore, a user can interrupt an operation of the system configuration derivation device 200 at any time.

### [Description of Effect]

The system configuration derivation device 200 in this example embodiment can be stopped at any time according to a command from a user. Thereby, when a user is satisfied with a system configuration presented by the solution conversion unit 105 during an optimization process, the user can end the optimization process at any time.

The system configuration derivation device 200 in this example embodiment is a device that assumes that interruption is possible. Therefore, interruption can be applied to system optimization problems where there is a prospect that an optimization process will not be finished in terms of size or complexity. As a result, it is possible to compute good feasible solutions as time permits.

### Example Embodiment 3

### [Description of Configuration]

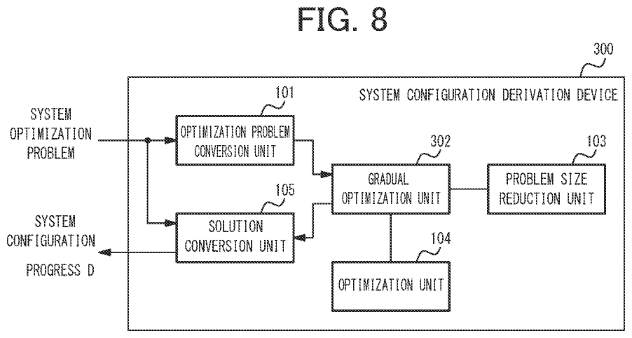

Next, the third example embodiment will be explained with reference to the drawings. FIG. 8 is a block diagram showing an example configuration of the third example embodiment of a system configuration derivation device 300.

The system configuration derivation device 300 has a gradual optimization unit 302 instead of the gradual optimization unit 102 in the configuration of the system configuration derivation device 100. The other configuration is the same as that of the system configuration derivation device 100.

It should be noted that the gradual optimization unit 102 and the gradual optimization unit 302 are the same with respect to input and output.

### [Description of Operation]

A basic operation of the system configuration derivation device 300 in this example embodiment is the same as that of the system configuration derivation device 100 in the first example embodiment. Only an operation of the gradual optimization unit 302 is described below.

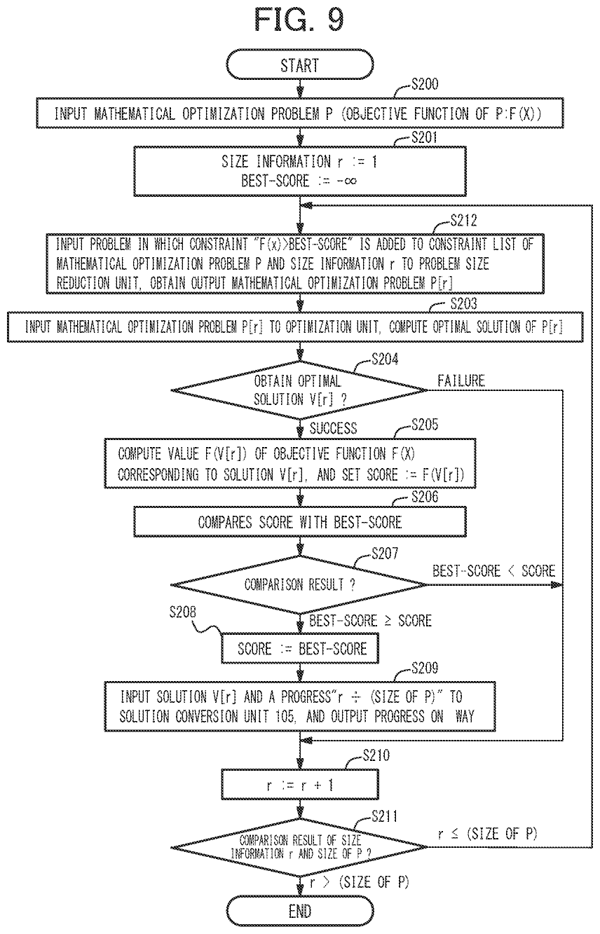

FIG. 9 is a flowchart describing an operation of the gradual optimization unit 302.

The gradual optimization unit 302 executes the process of step S212 instead of the process of step S202 in the flowchart shown in FIG. 3. The rest of the process is the same as the operation of the gradual optimization unit 102 in the first example embodiment. Only a processing of step 212 is described below.

The gradual optimization unit 302 inputs a problem in which a constraint “F(x)>BEST-SCORE” is added to a constraint list of a mathematical optimization problem P and size information r to the problem size reduction unit 103, obtains an output mathematical optimization problem P[r] (step S212).

By executing the process of step S212, a constraint that forces an output of a satisfactory solution is added to problems that are subsequently input to the optimization unit 104 based on information on the best feasible solution (in terms of an objective function) output from the optimization unit 104.

The system interruption unit 201 in the second example embodiment may be incorporated in the system configuration derivation device 300 of the third example embodiment. In such a configuration, the system interruption unit 201 can still issue interrupt instructions to other connected devices. A block in the system configuration deriving device 300 that receives the interrupt instruction immediately stops operating in case it is in operation.

### [Description of Effect]

In the process of solving an optimization problem while increasing size information, the gradual optimization unit 302 adds constraints to a newly solved mathematical optimization problem. In other words, the gradual optimization unit 302 converts an optimization problem into a problem such that no solution other than “a solution that updates a score of the best solution obtained so far” will be a feasible solution.

In general, in a mathematical optimization device, the stronger the given constraint, the smaller the search range and the shorter the time it takes to find an optimal solution. However, the system configuration derivation device 300 in this example embodiment can present an optimal solution in a shorter time than the system configuration derivation device 100 in the first example embodiment.

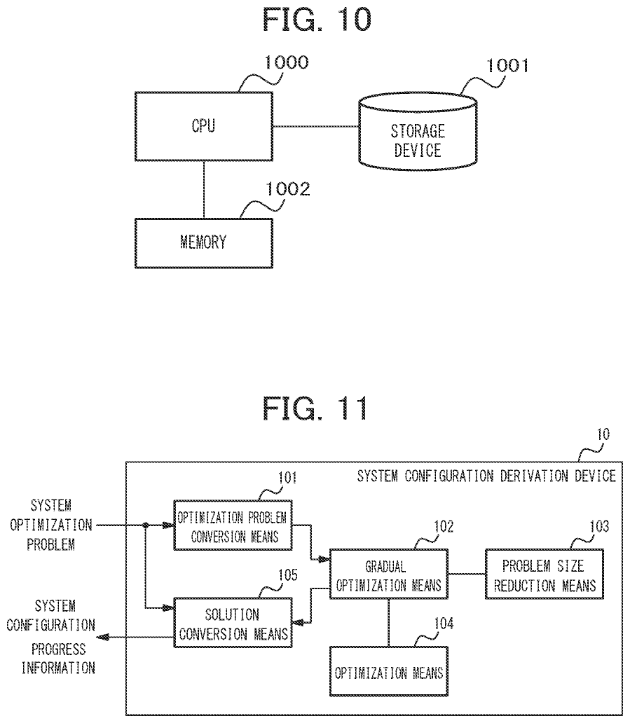

FIG. 10 is a block diagram of a computer with a CPU. The computer is implemented in a data processing device; a CPU 1000 realizes each function in the above example embodiments by executing processing according to a program (software element: codes) stored in a storage device 1001.

That is, the computer can realize functions of the optimization problem conversion unit 101, the gradual optimization unit 102, the problem size reduction unit 103, the optimization unit 104, and the solution conversion unit 105 in the system configuration derivation device 100 shown in FIG. 1. The computer can also realize functions of the optimization problem conversion unit 101, the gradual optimization unit 102, the problem size reduction unit 103, the optimization unit 104, the solution conversion unit 105, and the system interruption unit 201 in the system configuration derivation device 200 shown in FIG. 7. The computer can also realize functions of the optimization problem conversion unit 101, the gradual optimization unit 302, the problem size reduction unit 103, the optimization unit 104, and the solution conversion unit 105 in the system configuration derivation device 100 shown in FIG. 8.

The storage device 1001 is, for example, a non-transitory computer readable media. The non-transitory computer readable medium is one of various types of tangible storage media. Specific examples of the non-transitory computer readable media include a magnetic storage medium (for example, hard disk), a magneto-optical storage medium (for example, magneto-optical disk), a CD-ROM (Compact Disc-Read Only Memory), a CD-R (Compact Disc-Recordable), a CD-R/W (Compact Disc-ReWritable), and a semiconductor memory (for example, a mask ROM, a PROM (programmable ROM), an EPROM (Erasable PROM), a flash ROM).

The program may be stored in various types of transitory computer readable media. The transitory computer readable medium is supplied with the program through, for example, a wired or wireless communication channel, i.e., through electric signals, optical signals, or electromagnetic waves.

A memory 1002 is a storage means implemented by a RAM (Random Access Memory), for example, and temporarily stores data when the CPU 1000 executes processing. It can be assumed that a program held in the storage device 1001 or a temporary computer readable medium is transferred to the memory 1002 and the CPU 1000 executes processing based on the program in the memory 1002.

FIG. 11 is a block diagram showing the main part of a system configuration derivation device. A system configuration derivation device 10 shown in FIG. 11 includes an optimization problem conversion means 11 that converts a system optimization problem into a mathematical optimization problem, a problem size reduction means 13 that reduces the number of variables in the mathematical optimization problem by adding a constraint to the mathematical optimization problem, an optimization means 14 that computes a solution to the mathematical optimization problem with a reduced number of variables, a gradual optimization means 12 that sequentially outputs the solution, and progress information of a process, and a solution conversion means 15 that converts the solution into system configuration information, which is a solution to the system optimization problem and outputs the system configuration information and the progress information.

1. A system configuration derivation device, comprising:
a memory storing software instructions, and
one or more processors configured to execute the software instructions to
convert a system optimization problem into a mathematical optimization problem;
reduce the number of variables in the mathematical optimization problem by adding a constraint to the mathematical optimization problem;
compute a solution to the mathematical optimization problem with a reduced number of variables;
sequentially output the solution, and progress information of a process; and
convert the solution into system configuration information, which is a solution to the system optimization problem, and output the system configuration information and the progress information.

2. The system configuration derivation device according to claim 1, wherein
the one or more processors are configured to execute the software instructions to compute the solution to the mathematical optimization problem using a general-purpose optimization algorithm capable of finding an optimal solution to an optimization problem that minimizes an objective function defined by a linear function or a quadratic function defined on a binary variable and subject to a linear equality constraint or a linear inequality constraint.

3. The system configuration derivation device according to claim 1, wherein
the one or more processors are configured to execute the software instructions to replace a variable included in an objective function and a constraint with another variable for the mathematical optimization problem.

4. The system configuration derivation device according to claim 3, wherein
the one or more processors are configured to execute the software instructions to
generate a one-hot vector sequence based on a decision variable included in the mathematical optimization problem and include the one-hot vector sequence in the mathematical optimization problem, and
reduce the number of variables included in the objective function and the constraint of the mathematical optimization problem by subdividing the one-hot vector sequence based on size information and performing a conversion to replace another variable vector with a single variable vector included in the subdivided vector sequence.

5. The system configuration derivation device according to claim 2, wherein
the one or more processors are configured to execute the software instructions to replace a variable included in an objective function and a constraint with another variable for the mathematical optimization problem.

6. The system configuration derivation device according to claim 5, wherein
the one or more processors are configured to execute the software instructions to
generate a one-hot vector sequence based on a decision variable included in the mathematical optimization problem and include the one-hot vector sequence in the mathematical optimization problem, and
reduce the number of variables included in the objective function and the constraint of the mathematical optimization problem by subdividing the one-hot vector sequence based on size information and performing a conversion to replace another variable vector with a single variable vector included in the subdivided vector sequence.

7. The system configuration derivation device according to claim 1, wherein
the one or more processors are configured to execute the software instructions to add a constraint to the mathematical optimization problem that forces an output of a satisfactory solution.

8. The system configuration derivation device according to claim 2, wherein
the one or more processors are configured to execute the software instructions to add a constraint to the mathematical optimization problem that forces an output of a satisfactory solution.

9. The system configuration derivation device according to claim 1, wherein
the one or more processors are configured to execute the software instructions to
generate an interrupt instruction indicating a stop of operation.

10. A system configuration derivation method, comprising:
converting, by a computer, a system optimization problem into a mathematical optimization problem;
reducing, by the computer, the number of variables in the mathematical optimization problem by adding a constraint to the mathematical optimization problem;
computing, by the computer, a solution to the mathematical optimization problem with a reduced number of variables;
sequentially outputting, by the computer, the solution, and progress information of a process; and
converting, by the computer, the solution into system configuration information, which is a solution to the system optimization problem, and outputting the system configuration information and the progress information.

11. A non-transitory computer readable recording medium storing a system configuration derivation program for causing a computer to execute:
converting a system optimization problem into a mathematical optimization problem;
reducing the number of variables in the mathematical optimization problem by adding a constraint to the mathematical optimization problem;
computing a solution to the mathematical optimization problem with a reduced number of variables;
sequentially outputting the solution, and progress information of a process; and
converting the solution into system configuration information, which is a solution to the system optimization problem, and outputting the system configuration information and the progress information.
